(19) United States
(12) Patent Application Publication
(10) Pub. No.: US 2024/0222967 A1
(43) Pub. Date: Jul. 4, 2024

(54) POWER SUPPLY SYSTEM

(71) Applicant: DENSO CORPORATION, Kariya-city (JP)

(72) Inventors: Yasuhito TANABE, Kariya-city (JP); Dachao WANG, Kariya-city (JP)

(73) Assignee: DENSO CORPORATION, Kariya-city (JP)

(21) Appl. No.: 18/606,183

(22) Filed: Mar. 15, 2024

Related U.S. Application Data
(63) Continuation of application No. PCT/JP2022/032787, filed on Aug. 31, 2022.

(30) Foreign Application Priority Data
Sep. 17, 2021 (JP) 2021-152527

(51) Int. Cl. H02J 1/08; B60L 50/60; B60L 53/60; H02J 1/10; H02J 7/00; H02J 7/34

(52) U.S. Cl. CPC H02J 1/084; H02J 1/082; H02J 1/122; H02J 7/0031; H02J 7/0047; H02J 7/007182; H02J 7/342; H02J 7/345; B60L 50/60; B60L 53/60

(57) ABSTRACT

A power supply system includes a main relay provided on a high-voltage path between a high-voltage battery and electrical equipment, a charging relay provided on a charging path connected between the main relay and the electrical equipment, and a control device that controls opening and closing of the main relay and the charging relay. The control device, the main relay, and the charging relay operate using electrical power supplied from a low-voltage battery. In a state in which the main relay and the charging relay are closed, the high-voltage battery is charged by charging it with power supplied from a charging device. In addition, the power supply system includes a relay interruption unit that interrupts the charging relay before interrupting the main relay if a voltage reduction abnormality of the low-voltage battery has occurred under a state in which both the main relay and the charging relay are closed.

### CROSS-REFERENCE TO RELATED APPLICATION

The present application is based on and claims the benefit of priority from earlier Japanese Patent Application No. 2021-152527 filed on Sep. 17, 2021, the description of which is incorporated herein by reference.

### BACKGROUND

### Technical Field

The disclosure of the description relates to a power supply system.

### Related Art

For example, a power supply system for a vehicle is known. In the power supply system, a main relay is provided to an electrical power path connected to a battery, a charging relay is provided to a charging path connected to the electrical power path, and opening and closing of the main relay and the charging relay are controlled by a control unit. When the vehicle is normally operating, the main relay is closed, whereby electrical power is supplied from the battery to electrical equipment such as an inverter, a rotary electric machine, and an electrical power converter connected between the main relay and the charging relay. In addition, when the battery is charged, the main relay and the charging relay are closed, whereby the battery is charged by charging it with power supplied from a charging device.

### SUMMARY

According to an aspect of the present disclosure, a power supply system is provided which includes: a main relay that is provided on a high-voltage path between a high-voltage battery and electrical equipment; a charging relay provided on a charging path connected between the main relay and the electrical equipment; and a control device that controls opening and closing of the main relay and the charging relay. The control device, the main relay, and the charging relay operate using electrical power supplied from a low-voltage battery. In a state in which the main relay and the charging relay are closed, the high-voltage battery is charged by charging it with power supplied from a charging device via the charging path. The power supply system further includes a relay interruption unit that interrupts the charging relay before interrupting the main relay if a voltage reduction abnormality of the low-voltage battery has occurred under a state in which both the main relay and the charging relay are closed.

### BRIEF DESCRIPTION OF THE DRAWINGS

In the accompanying drawings:

FIG. 1 is a block diagram illustrating a power supply system of a first embodiment;

FIG. 2 is a flowchart illustrating a processing procedure of external charging control for a high-voltage battery;

FIG. 3 is a time diagram for describing the external charging control in detail;

FIG. 4 is a block diagram illustrating a power supply system of a second embodiment;

FIG. 5 is a time diagram for describing operation when charging according to the second embodiment;

FIG. 6 is a block diagram illustrating a power supply system of the second embodiment;

FIG. 7 is a block diagram illustrating a power supply system of a third embodiment;

FIG. 8 is a circuit diagram illustrating a configuration of a relay drive circuit;

FIG. 9 is a time diagram illustrating operation of the relay drive circuit when a charging relay is closed;

FIG. 10 is a diagram for describing operation of the relay drive circuit;

FIG. 11 is a block diagram illustrating a power supply system of a fourth embodiment;

FIG. 12 is a time diagram for describing operation when charging according to the fourth embodiment;

FIG. 13 is a block diagram illustrating a power supply system of a fifth embodiment;

FIG. 14 is a time diagram for describing operation when charging according to the fifth embodiment;

FIG. 15 is a block diagram illustrating a power supply system of a sixth embodiment;

FIG. 16 is a time diagram for describing operation when charging according to the sixth embodiment; and

FIG. 17 is a flowchart illustrating a relay interruption process according to a modification.

### DETAILED DESCRIPTION OF THE PREFERRED EMBODIMENTS

For example, as a power supply system for a vehicle, the technique disclosed in JP 2019-154170 A is known. In the power supply system, a main relay is provided to an electrical power path connected to a battery, a charging relay is provided to a charging path connected to the electrical power path, and opening and closing of the main relay and the charging relay are controlled by a control unit.

When the vehicle is normally operating, the main relay is closed, whereby electrical power is supplied from the battery to electrical equipment such as an inverter, a rotary electric machine, and an electrical power converter connected between the main relay and the charging relay. In addition, when the battery is charged, the main relay and the charging relay are closed, whereby the battery is charged by charging it with power supplied from a charging device.

For example, a configuration having a high-voltage battery as a battery in an electrically driven vehicle, it is assumed that a low-voltage battery is provided as a power source different from the high-voltage battery, and the main relay and the charging relay are opened and closed using electrical power supply from the low-voltage battery. Here, if the voltage of the low-voltage battery is abnormally decreased due to a disconnection, a ground fault, or the like, opening and closing of the main relay and the charging relay cannot be appropriately controlled, whereby there is a concern that a malfunction due to that may be caused. That is, when voltage of the low-voltage battery is abnormal, each relay is interrupted in the course of events. If the main relay is interrupted before the charging relay is interrupted, voltage increases due to a load dump between the main relay and the charging relay. Due to this, there is a concern that a malfunction may occur in the electrical equipment connected between the main relay and the charging relay.

In view of the above points, the present disclosure has an object of providing a power supply system that can take appropriate measures, when a high-voltage battery is charged, even if a voltage reduction abnormality of a low-voltage battery is caused.

Hereinafter, embodiments will be described with reference to the drawings. In the embodiments, a power supply system installed in an electrically driven vehicle is embodied, and a high-voltage battery of the electrically driven vehicle can be charged by a charging device outside the vehicle.

### First Embodiment

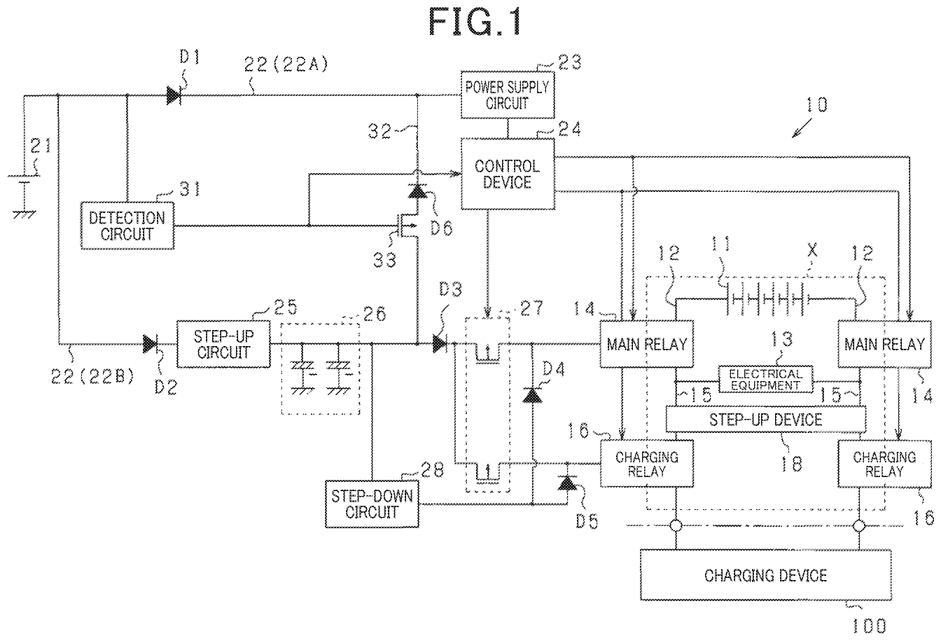

FIG. 1 is a block diagram of a power supply system 10 in a 20) vehicle. In FIG. 1, the power supply system 10 has a high-voltage battery 11. A high-voltage path 12 connected to the positive electrode side and the negative electrode side of the high-voltage battery 11 is connected with electrical equipment 13. The high-voltage battery 11 is a lithium-ion storage battery in which a plurality of battery cells are connected in series and a high-voltage secondary battery whose positive side voltage is several hundred volts (e.g., 800 V). In addition, the electrical equipment 13 may be an inverter, a rotary electric machine, an electrical power converter (DC-DC converter), or the like. When the inverter and the rotary electric machine are included as the electrical equipment 13, high-voltage electrical power of the high-voltage battery 11 is supplied to the rotary electric machine by switching control for switching elements of the inverter. On the high-voltage path 12, main relays 14 are respectively provided to the positive electrode side and the negative electrode side of the high-voltage battery 11. If the main relay 14 is closed, electrical power is supplied from the high-voltage battery 11 to the electrical equipment 13.

In addition, in the power supply system 10, the high-voltage battery 11 can be charged by a charging device 100 outside the vehicle. In a state in which the charging device 100 is connected to a power connector of the vehicle, the high-voltage battery 11 is charged by charging it with power supplied from the charging device 100.

The power supply system 10 includes, as a configuration for external charging, a charging path 15 connected at an intermediate point between the main relay 14 and the electrical equipment 13 on the high-voltage path 12, and a charging relay 16 provided to the charging path 15. In the present embodiment, the main relay 14 and the charging relay 16 are respectively provided to the positive electrode side and the negative electrode side of the high-voltage battery 11. However, for example, the main relay 14 and the charging relay 16 may be provided to any one of the positive electrode side and the negative electrode side. When external charging is performed by the charging device 100, charging power is supplied from the charging device 100 to the high-voltage battery 11 in a state in which both the main relay 14 and the charging relay 16 are closed, and the high-voltage battery 11 is charged by charging it with power.

It is noted that a step-up device 18 that boosts (steps-up) charging power may be provided between the main relay 14 and the charging relay 16. For example, if the voltage of the high-voltage battery 11 is higher than the voltage of the charging power of the charging device 100, the charging power is boosted (stepped-up) by the step-up device 18, and the high-voltage battery 11 is charged by the boosted charging power.

In the power supply system 10, the high-voltage battery 11 and the above configurations operated by high voltage of the high-voltage battery 11 correspond to a high-voltage operation unit. In FIG. 1, the high-voltage operation unit is denoted by X. The main relay 14 and the charging relay 16 are electromagnetic relays. The electromagnetic relay includes an exciting coil on the low-voltage side and a relay switch on the high-voltage side which is closed (turned on) by energization of the exciting coil. Of them, the relay switch belongs to the high-voltage operation unit X.

Next, a configuration of a low-voltage system of the power supply system 10 which operates by battery voltage (low voltage) of a low-voltage battery 21 will be described.

The low-voltage battery 21 is connected with a low-voltage path 22, which is connected with a power supply circuit 23. In addition, the power supply circuit 23 is connected with a control device 24. The low-voltage battery 21 is, for example, a lead storage battery having a rating of 12 V. Constant voltage Vcc (e.g., 5 V) is generated in the power supply circuit 23 by the battery voltage of the low-voltage battery 21. Then, the control device 24 is operated by the constant voltage Vcc. The control device 24 is configured by a microcomputer having well-known CPU, memory, and the like. The control device 24 controls opening and closing of the main relay 14 based on a vehicle driving request or the like and controls opening and closing of the main relay 14 and the charging relay 16 based on a charging request for the high-voltage battery 11 or the like. The control device 24 operates an excitation state of the exciting coil in the main relay 14 and the charging relay 16, which are electromagnetic relays, to control opening and closing of the relays 14 and 16.

The low-voltage path 22 connected to the low-voltage battery 21 branches into two ways, one of which is a path connected to the power supply circuit 23 as describe above, and the other of which is a path connected to the exciting coils of the main relay 14 and the charging relay 16. In the following description, the low-voltage path 22 on the power supply circuit 23 side is referred to as a control power supply path 22A, and the low-voltage path 22 on the relays 14, 16 side is referred to as a relay power supply path 22B. The control power supply path 22A supplies power supply electrical power of the control device 24. The relay power supply path 22B supplies drive electrical power of the relays 14, 16.

The following is basic operation of the relays 14, 16. When closing the relays 14, 16 from opened states, the control device 24 outputs closing command signals to the relays 14, 16. Hence, the exciting coils are excited in the relays 14, 16. Due to the excitation, the relay switches are closed, whereby the relays 14, 16 become closed states. In addition, if the output of the closing command signals from the control device 24 is stopped, the excitation of the exciting coils of the relays 14, 16 is stopped, and the relay switches are opened, whereby the relays 14, 16 return to opened states.

In addition, the relay power supply path 22B is provided with a step-up circuit 25 that boosts battery voltage of the low-voltage battery 2, a step-up capacitor 26 that is charged by the boosted voltage of the step-up circuit 25, a voltage changing switch 27 provided between the step-up capacitor 26 and the relays 14, 16, and a step-down circuit 28 that is also provided between the step-up capacitor 26 and the relays 14, 16. The voltage changing switch 27 and the step-down circuit 28 may be provided in parallel. The step-up capacitor 26 stores, by step-up operation of the step-up circuit 25, step-up energy having voltage higher than the battery voltage of the low-voltage battery 21. The step-down circuit 28 drops (steps-down) the voltage of the step-up capacitor 26. The boosted voltage of the step-up circuit 25 is, for example, 20 V. The dropped (stepped-down) voltage of the step-down circuit 28 is, for example, 5 V. The voltage changing switch 27 switches between a state in which boosted voltage of the step-up capacitor 26 is applied to the relays 14, 16 and a state in which dropped voltage of the step-down circuit 28 is applied to the relays 14, 16.

When the high-voltage battery 11 is charged, when starting is commenced, the voltage changing switch 27 is turned by the control device 24, whereby the relays 14, 16 are excited (driven) by the boosted voltage of the step-up capacitor 26. Hence, the relays 14, 16 can be reliably shifted from an opened state (off state) to a closed state (on state). In addition, the voltage changing switch 27 is turned off at the point of time at which a predetermined time period has elapsed from the start of charging. In a state in which the voltage changing switch 27 is turned off, the excitation states (drive states) of the relays 14, 16 are held using electrical power supplied from the step-down circuit 28. It can be said that the dropped voltage of the step-down circuit 28 is a holding voltage for holding the excitation states (drive states) of the relays 14, 16. In this case, the relays 14, 16 can be driven using saved electrical power.

The low-voltage path 22 is provided with a plurality of diodes as regulation elements that regulate the direction of energization. Specifically, the control power supply path 22A is provided with a diode D1 whose cathode is located on the power supply circuit 23 side. On the relay power supply path 22B, a diode D2 whose cathode is located on the step-up circuit 25 side is provided between the low-voltage battery 21 and the step-up circuit 25, and a diode D3 whose cathode is located on the voltage changing switch 27 side is provided between the step-up capacitor 26 and the voltage changing switch 27. In addition, diodes D4, D5 whose cathodes are located on the relays 14, 16 sides are provided between the step-down circuit 28 and the relays 14, 16.

Incidentally, if voltage of the low-voltage battery 21 decreases on the low-voltage side of the power supply system 10 due to a disconnection, a ground fault, or the like, it can be considered that opening and closing of the relays 14, 16 cannot be appropriately controlled due to the decrease. If the main relay 14 is interrupted before the charging relay 16 is interrupted, there is a concern that voltage excessively increases due to a load dump between the main relay 14 and the charging relay 16. Hence, in the present embodiment, if a voltage reduction abnormality of the low-voltage battery 21 has occurred under a state in which both the main relay 14 and the charging relay 16 are closed, the control device 24 interrupts the charging relay 16 before interrupting the main relay 14 during a time period during which backup electrical power generated by using the step-up capacitor 26 as a power supply is supplied to the main relay 14 and the charging relay 16. In the present embodiment, the control device 24 corresponds to a relay interruption unit. In addition, the step-up capacitor 26 and the step-down circuit 28 correspond to a backup power supply unit that supplies backup electrical power.

Specifically, the low-voltage path 22 is provided with a detection circuit 31 that detects voltage reduction in the low-voltage battery 21. In addition, on the low-voltage path 22, the control power supply path 22A and the downstream side of the step-up capacitor 26 on the relay power supply path 22B are connected via a connection path 32, which is provided with a backup changing switch 33. The connection path 32 is provided with a diode D6 whose cathode is located on the power supply circuit 23 side. In addition, it is configured to output a detection result of the detection circuit 31 is output to the control device 24, in addition to change on-off of the backup changing switch 33 according to the detection result of the detection circuit 31.

In this case, at normal times, a non-detection signal indicating that voltage reduction is not detected is output from the detection circuit 31, whereby the backup changing switch 33 is kept to an off state. In addition, if the voltage of the low-voltage battery 21 decreases due to a disconnection or the like, a detection signal indicating that voltage reduction is detected is output as a detection result of the detection circuit 31, whereby the backup changing switch 20) 33 is turned on by the detection signal. It is noted that, for example, when a P-channel MOSFET is used as the backup changing switch 33, a low level signal is output from the detection circuit 31 as a detection signal, whereby the backup changing switch 33 is turned on. Then, in a state in which backup electrical power is supplied from the step-up capacitor 26, the control device 24 determines that a voltage reduction abnormality of the low-voltage battery 21 has occurred based on the detection signal of the detection circuit 31 and sequentially interrupts the relays 14, 16.

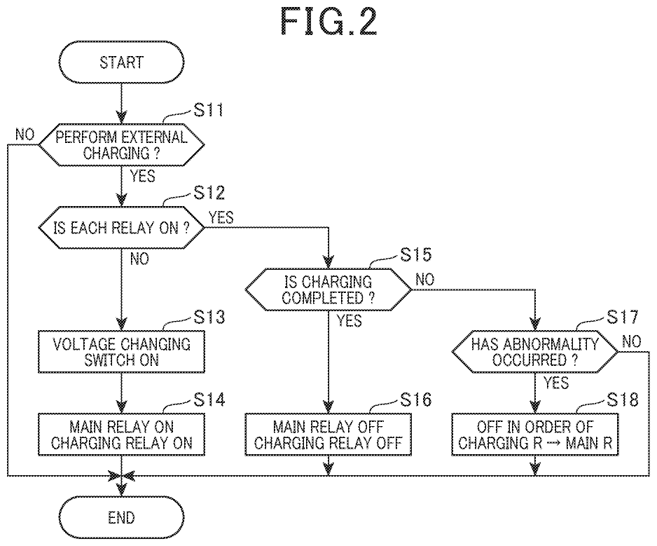

FIG. 2 is a flowchart illustrating a processing procedure of external charging control for the high-voltage battery 11. The present process is repeatedly performed by the control device 24 at predetermined intervals.

In FIG. 2, in step S11, based on presence or absence of an external charging request or the like, it is determined whether to perform external charging for the high-voltage battery 11 by the charging device 100. Then, if it is determined to perform external charging, the process proceeds to step S12. In step S12, it is determined whether both the main relay 14 and the charging relay 16 are in on states (closed states). Then, if the relays 14, 16 are not in on states, the process proceeds to step S13. If the relays 14, 16 are in on states, the process proceeds to step S15.

In step S13, the voltage changing switch 27 is turned on. In succeeding step S14, the relays 14, 16 are turned on. Hence, as exciting voltage of the relays 14, 16, boosted voltage higher than the battery voltage of the low-voltage battery 21 is applied. Then, the relay switches of the relays 14, 16 are turned on, whereby a path connecting the charging device 100 to the high-voltage battery 11 is opened, and charging the high-voltage battery 11 is started. It is noted that the voltage changing switch 27 may be turned on only during a predetermined time period from the start of charging (i.e., from when the relays 14, 16 are turned on) and may be turned off, for example, by a timer. The predetermined time period may be, for example, approximately 10 msec.

In addition, in step S15, it is determined whether external charging for the high-voltage battery 11 is completed. For example, when a charging completion signal is input to the control device 24, it may be determined that external charging is completed. Then, if the external charging is completed, the process proceeds to step S16, in which the main relay 14 and the charging relay 16 are turned off.

In contrast, if the external charging is not completed, the process proceeds to step S17, in which it is determined whether a voltage reduction abnormality of the low-voltage battery 21 has occurred. This determination is performed based on a detection result of the detection circuit 31. If a detection signal indicating that voltage reduction is detected is input to the control device 24 as a detection result of the detection circuit 31, it is determined that a voltage reduction abnormality of the low-voltage battery 21 has occurred. That is, in step S17, the control device 24 determines presence or absence of a voltage reduction abnormality of the low-voltage battery 21 after the relays 14, 16 are turned on and external charging starts.

Then, if no voltage reduction abnormality of the low-voltage battery 21 has occurred, the present process temporarily ends without change. In contrast, if a voltage reduction abnormality of the low-voltage battery 21 has occurred, the process proceeds to step S18. In step S18, the relays 14, 16 are turned off in such order that the charging relay 16 is the first and the main relay 14 is the second. For example, the control device 24 turns off the charging relay 16 first, and turns off the main relay 14 after a predetermined time period has elapsed after the charging relay 16 is turned off. When the relays 14, 16 are turned off, the path connecting the charging device 100 to the high-voltage battery 11 is interrupted, whereby charging the high-voltage battery 11 is forcibly stopped.

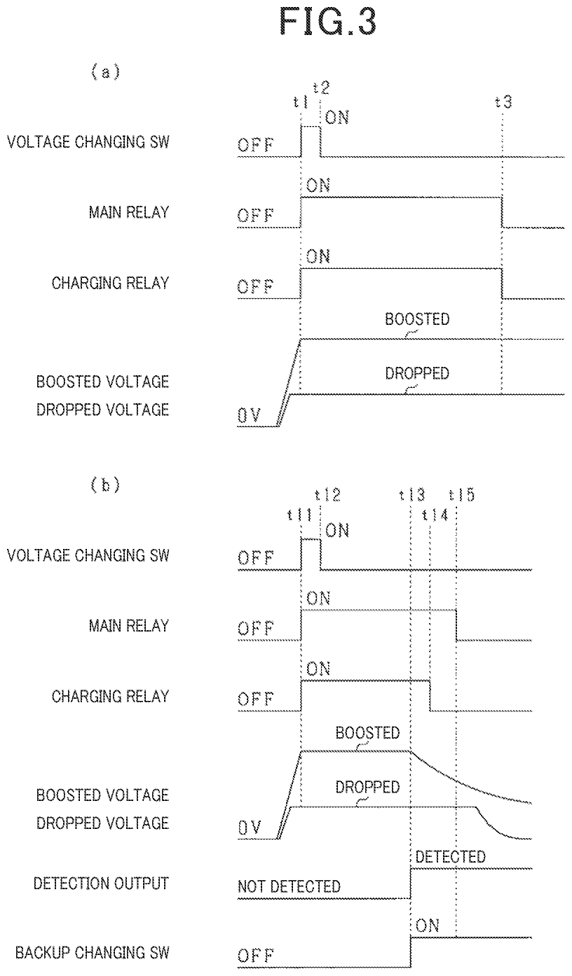

FIG. 3 is a time diagram for describing the external charging control described above in detail. In FIG. 3, (a) illustrates a normal operation in which no voltage reduction abnormality of the low-voltage battery 21 has occurred, and (b) illustrates an operation in which a voltage reduction abnormality of the low-voltage battery 21 has occurred.

In FIG. 3(a), at timing t1, external charging for the high-voltage battery 11 starts. At this time, the voltage changing switch 27, the main relay 14, and the charging relay 16 are turned on. It is noted that, as illustrated, it is desirable that, at the point of time at which the voltage changing switch 27 and the relays 14, 16 are turned on, the 25 boosted voltage of the step-up capacitor 26 has reached a predetermined target voltage. When starting driving the relays 14, 16 is commenced, as exciting voltage of the relays 14, 16, boosted voltage higher than the battery voltage of the low-voltage battery 21 is applied. Then, when the relays 14, 16 are turned on, a path connecting the charging device 100 to the high-voltage battery 11 is opened, and charging the high-voltage battery 11 is started.

Thereafter, at timing t2, the voltage changing switch 27 is turned off. Hence, the dropped voltage dropped by the step-down circuit 28 is applied to the relays 14, 16. Applying the dropped voltage holds on states (drive states) of the relays 14, 16. At this time, since the on states are held by the dropped voltage lower than the battery voltage of the low-voltage battery 21, the relays 14, 16 are driven using saved electrical power.

Thereafter, at timing t3, when external charging for the high-voltage battery 11 is completed, the main relay 14 and the charging relay 16 are turned off. Hence, a sequence of the external charging control is ended.

Meanwhile, as in FIG. 3(a), FIG. 3(b) illustrates a state in which when the voltage changing switch 27, the main relay 14, and the charging relay 16 are turned on, external charging for the high-voltage battery 11 is started (timing t11), and when the voltage changing switch 27 is turned off, dropped voltage is applied to the relays 14, 16 (timing t12).

Then, at timing t13, if the voltage of the low-voltage battery 21 decreases to 0V due to, for example, a disconnection, output of the detection circuit 31 changes from a non-detection signal to a detection signal due to the voltage reduction. Hence, the backup changing switch 33 is immediately turned on, whereby electrical power is supplied from the step-up capacitor 26 to the control device 24 via the power supply circuit 23. That is, it becomes a backup power supply state in which the step-up capacitor 26 is used as a backup power supply, whereby power shutdown of the control device 24 is suppressed. In addition, since a detection signal of the detection circuit 31 is input to the control device 24, the control device 24 detects occurrence of an abnormality.

In addition, at timing t13, the relays 14, 16 are driven by application of dropped voltage generated from boosted voltage of the step-up capacitor 26. Also after timing t13, application of dropped voltage is maintained. In this case, since the application of dropped voltage is maintained, the drive states of the relays 14, 16 are maintained. After timing t13, boosted electrical power of the step-up capacitor 26 is supplied to the control device 24 as backup electrical power, and dropped electrical power of the step-down circuit 28 is supplied to the main relay 14 and the charging relay 16 as backup electrical power.

Here, after timing t13, the step-up operation is stopped in the step-up circuit 25 due to input voltage reduction, and charging the step-up capacitor 26 is accordingly stopped. However, since the relays 14, 16 are driven by the dropped voltage, the gradient of voltage reduction of the step-up capacitor 26 is relatively gradual. Hence, for a while after timing t13, supply of operation electrical power to the control device 24 and supply of drive voltage of the relays 14, 16 can be continued.

Thereafter, at timings t14, t15, during a time period during which backup electrical power is supplied to the main relay 14 and the charging relay 16, the control device 24 turns off the relays 14, 16 in such order that the charging relay 16 is the first and the main relay 14 is the second. At this time, off operation of the charging relay 16 and off operation of the main relay 14 are performed with a time difference. However, since the gradient of voltage reduction of the step-up capacitor 26 is gradual, appropriate operation can be performed by the control device 24. When the relays 14, 16 are turned off as described above, a malfunction can be suppressed which excessively increases voltage due to a load dump between the main relay 14 and the charging relay 16 due to the interruption of the main relay 14 before the interruption of the charging relay 16.

According to the present embodiment described above in detail, the following significant effects can be obtained.

When external charging for the high-voltage battery 11 is performed, if a voltage reduction abnormality of the low-voltage battery 21 has occurred under a state in which both the main relay 14 and the charging relay 16 are closed, the charging relay 16 is interrupted before the main relay 14 is interrupted. Hence, a malfunction of the electrical equipment 13, due to the interruption of the main relay 14 before the interruption of the charging relay 16, can be suppressed. As a result, when the high-voltage battery 11 is charged, even if a voltage reduction abnormality of the low-voltage battery 21 occurs, appropriate measures can be taken.

Specifically, even if a voltage reduction abnormality of the low-voltage battery 21 occurs suddenly under a state in which both the main relay 14 and the charging relay 16 are closed, since backup electrical power is supplied to the control device 24, the main relay 14, and the charging relay 16, the closed states of the relays 14, 16 can be continued. Hence, during a time period during which backup electrical power is supplied to the relays 14, 16, the charging relay 16 can be appropriately interrupted before the main relay 14 is interrupted.

When starting charging the high-voltage battery 11 is commenced, boosted voltage of the step-up capacitor 26 is applied to shift the main relay 14 and the charging relay 16 from opened states to closed states. Thereafter, the applied voltage is changed to dropped voltage of the step-down circuit 28 to hold the closed states of the main relay 14 and the charging relay 16. Hence, when the high-voltage battery 11 is charged, reliable relay drive can be performed by the boosted voltage of the step-up capacitor 26, and the relays 14 and 16 can be driven using saved energy with the dropped voltage.

In addition, if a voltage reduction abnormality of the low-voltage battery 21 has occurred under a state in which both the main relay 14 and the charging relay 16 are closed, the dropped electrical power of the step-down circuit 28 is supplied to the main relay 14 and the charging relay 16 as backup electrical power. Hence, even in a state in which electrical power supply from the low-voltage battery 21 to the step-up capacitor 26 is stopped, the supply of backup electrical power to the relays 14, 16 can be prolonged.

Hereinafter, other embodiments in which part of the first embodiment is modified will be described focusing on differences from the first embodiment.

### Second Embodiment

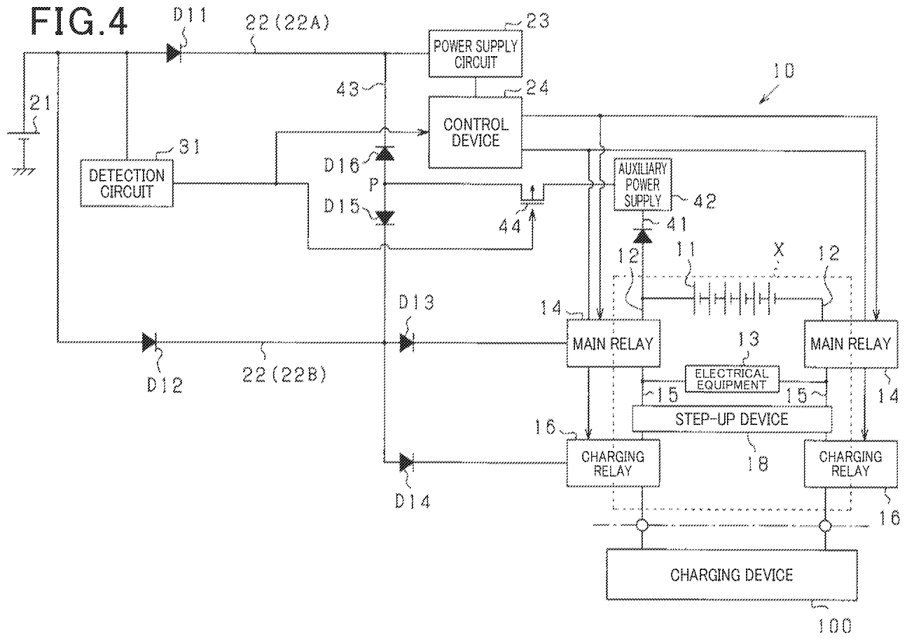

FIG. 4 is a block diagram of the power supply system 10 according to the present embodiment. In FIG. 4, as differences from FIG. 1, the configuration of the backup power supply unit that supplies backup electrical power to the control device 24 and the relays 14, 16 is modified. Instead of the configuration that generates backup electrical power from the electrical power of the low-voltage battery 21, a configuration that generates backup electrical power from the electrical power of the high-voltage battery 11 is provided.

In FIG. 4, the positive side terminal of the high-voltage battery 11 is connected with an auxiliary power supply circuit 42 via a connection path 41. For example, the auxiliary power supply circuit 42 has a power converter circuit that drops high voltage of the high-voltage battery 11 and a capacitor that is charged by the dropped voltage dropped by the power converter circuit. The dropped voltage is equivalent to the voltage of the low-voltage battery 21, for example, 12 V. However, the auxiliary power supply circuit 42 may be arbitrarily configured if it can generate backup electrical power using the high-voltage battery 11. The auxiliary power supply circuit 42 corresponds to an auxiliary power supply unit.

In addition, on the low-voltage path 22, the control power supply path 22A and the relay power supply path 22B are connected by a connection path 43. A backup changing switch 44 is provided between an intermediate point P on the connection path 43 and the auxiliary power supply circuit 42. The backup changing switch 44 is turned on or off according to a detection result of the detection circuit 31. The control power supply path 22A and the relay power supply path 22B are provided with diodes D11 to D14 as illustrated. In addition, on both sides of the intermediate point P on the connection path 43, the diodes D15, D16 are respectively provided in mutually opposite directions (back-to-back state).

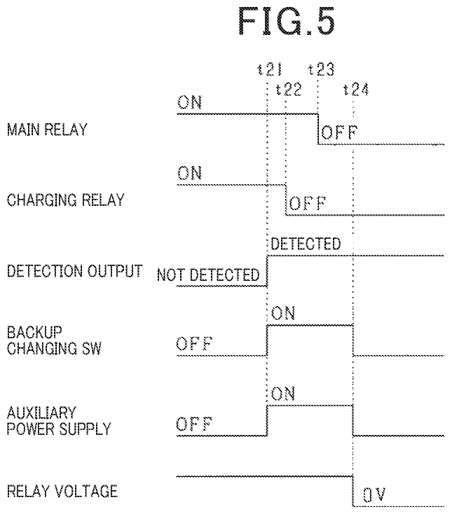

FIG. 5 is a time diagram for describing operation when charging according to the present embodiment. In FIG. 5, at timing t21 or before, both the main relay 14 and the charging relay 16 are closed (turned on). At timing t21, a voltage reduction abnormality of the low-voltage battery 21 occurs. In this case, at timing t21, a detection signal indicating that voltage reduction is detected is output as a detection result of the detection circuit 31, whereby the backup changing switch 44 is turned on by the detection signal. Hence, backup electrical power is supplied from the auxiliary power supply circuit 42 to the control device 24, the main relay 14, and the charging relay 16.

Then, the control device 24 determines that a voltage reduction abnormality of the low-voltage battery 21 has occurred based on the detection signal of the detection circuit 31 and sequentially interrupts the relays 14, 16. Specifically, the charging relay 16 is interrupted at timing t22, and the main relay 14 is interrupted at the following timing t23. In addition, at timing t24, the backup changing switch 44 is turned off, whereby supply of the backup electrical power from the auxiliary power supply circuit 42 is stopped.

According to the present embodiment, even in a state in which electrical power supply from the low-voltage battery 21 is stopped, the relays 14, 16 can be appropriately interrupted by the control device 24 while supply of backup electrical power to the relays 14, 16 is continued. In addition, in the above configuration, since the auxiliary power supply circuit 42 generates backup electrical power using the high-voltage battery 11, the time limit until backup electrical power is lost after the change to the backup electrical power can be eliminated.

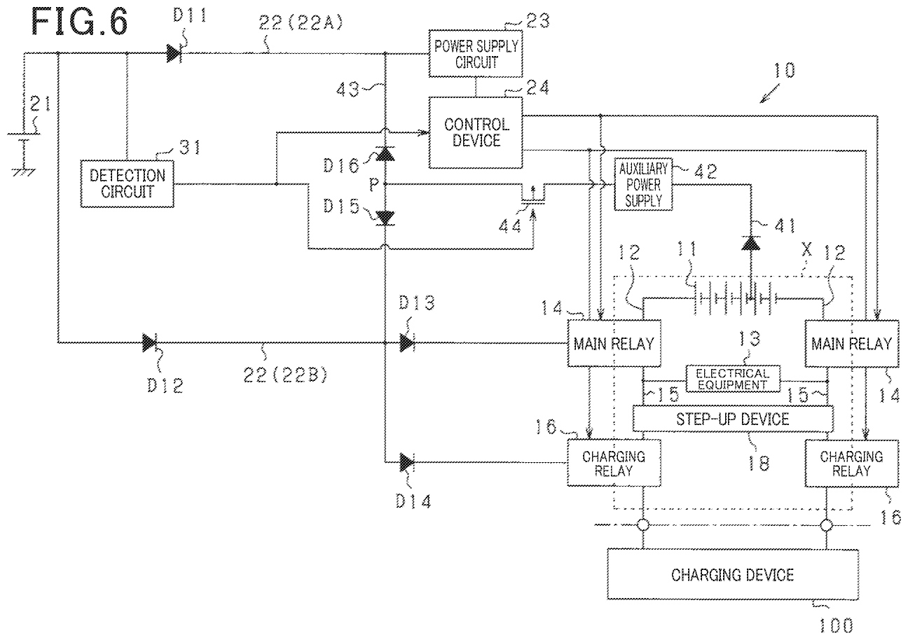

As a modification of the configuration illustrated in FIG. 4, the configuration illustrated in FIG. 6 may be used. In FIG. 6, as differences from FIG. 4, the auxiliary power supply circuit 42 is connected at an intermediate voltage position of the high-voltage battery 11 via the connection path 41. It is noted that the auxiliary power supply circuit 42 may receive voltage from at least one cell of the high-voltage battery 11 to generate backup electrical power.

### Third Embodiment

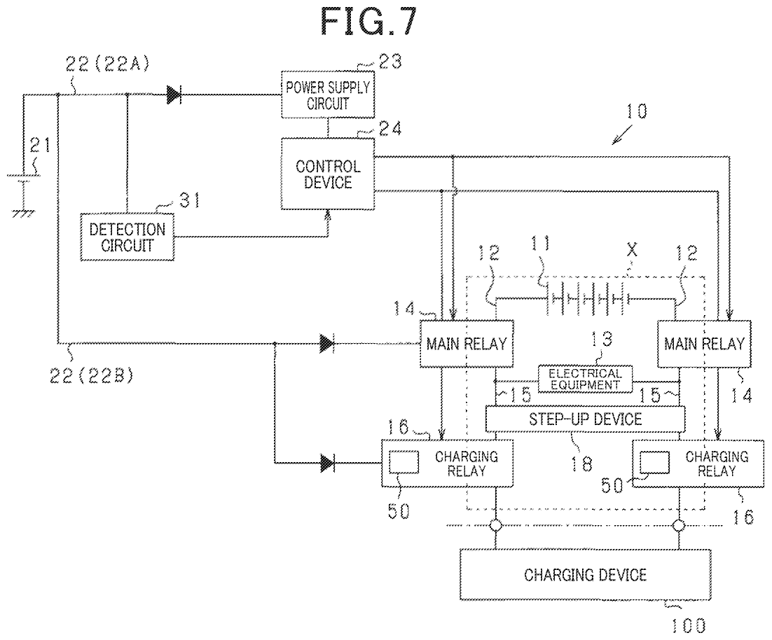

FIG. 7 is a block diagram of the power supply system 10 according to the present embodiment. In FIG. 7, as differences from FIG. 1, the configuration that supplies backup electrical power from the backup power supply unit to the control device 24 and the relays 14, 16 is omitted. Instead of this, the charging relay 16 is provided with a relay drive circuit 50 having a quick interruption function that can perform quicker interruption when the relay is desirably interrupted.

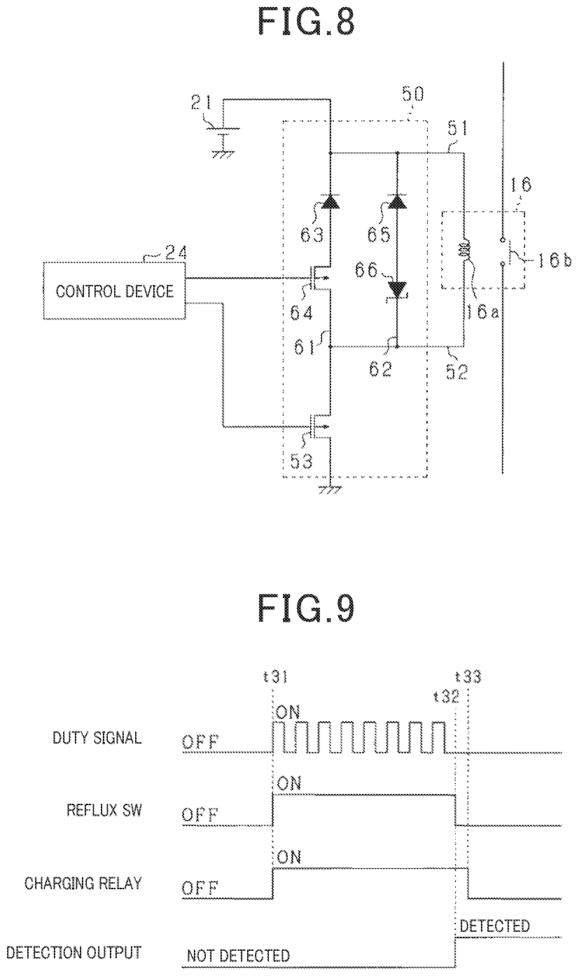

FIG. 8 is a circuit diagram illustrating a configuration of the relay drive circuit 50. In FIG. 8, the charging relay 16 has an exciting coil 16a and a relay switch 16b. A positive side path 51, which is one end side of the exciting coil 16a, is connected with the low-voltage battery 21. A negative side path 52, which is the other end side of the exciting coil 16a, is connected with an energization switch 53. It is noted that the paths 51, 52 correspond to the relay power supply path 22B in FIG. 7. In the present embodiment, the energization switch 53 is turned on and off by duty control. That is, when the charging relay 16 is closed, the control device 24 outputs a duty signal to the energization switch 53 to control electrical power supply from the low-voltage battery 21 to the exciting coil 16a.

In addition, between the positive side path 51 and the negative side path 52 of the exciting coil 16a, a first path 61 and a second path 62 are provided in parallel across both ends of the exciting coil 16a. On the first path 61, a diode 63 and a reflux switch 64 are provided in series. The diode 63 is provided so that the cathode thereof is located on the positive side path 51 side (the low-voltage battery 21 side). The reflux switch 64 is, for example, a MOSFET and is turned on and off by output of the control device 24.

In addition, the second path 62 is provided with a clamp circuit configured by a series connection of diodes 65, 66. The diode 65 is provided so that the cathode thereof is located on the positive side path 51 side (the low-voltage battery 21 side). The diode 66 is, for example, a Schottky-barrier diode, and is provided so that the cathode thereof is located on the negative side path 52 side.

The first path 61 and the second path 62 respectively form reflux paths including the charging relay 16. That is, making the reflux switch 64 an on state to make the first path 61 a conduction state forms a reflux path including the reflux switch 64. In addition, making energization of the diode 66 in the opposite direction to make the second path 62 a conduction state forms a reflux path including the diode 66. The diode 66 is a power consumption element whose power consumption is higher than that of the reflux switch 64 when reflux is made.

The relay drive circuit 50 is provided only to the charging relay 16 of the main relay 14 and the charging relay 16. It is noted that the relay drive circuit on the main relay 14 side may perform on-off control of energization of the exciting coil.

It is noted that, as the relay drive circuit on the main relay 14 side, as in the charging relay 16 side, a configuration may be used in which duty control is performed for energization of the exciting coil. In such a case, a configuration that does not have the second path 62 illustrated in FIG. 8 (i.e., a configuration that does not have a clamp circuit) may be used. In short, when the main relay 14 and the charging relay 16 are respectively provided with duty drive type relay drive circuits, only the relay drive circuit 50 on the charging relay 16 side of the relays 14 and 16 may have a quick interruption function.

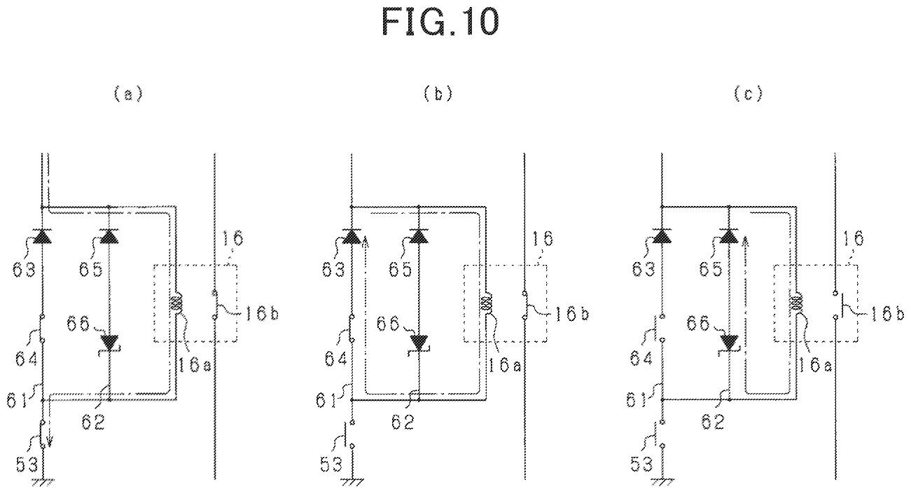

Next, specific operation of the relay drive circuit 50 will be described. FIG. 9 is a time diagram illustrating operation of the relay drive circuit 50 when the charging relay 16 is closed. FIG. 10 is a diagram for describing operation of the relay drive circuit 50.

In FIG. 9, at timing t31, when charging the high-voltage battery 11 starts, output of a duty signal to the energization switch 53 is started. In addition, the reflux switch 64 is turned on. When the output of the duty signal is started, the exciting coil 16a is excited, whereby the charging relay 16 becomes a closed state. Here, a state at duty on time and a state at duty off time will be described with 25 reference to FIGS. 10 (a), (b).

FIG. 10 (a) indicates a state at duty on time, in which the energization switch 53 is in an on state and the reflux switch 64 in an on state. In this case, energization current flows from the low-voltage battery 21 through the exciting coil 16a and the energization switch 53, whereby the exciting coil 16a is excited.

FIG. 10 (b) indicates a state when a shift from duty on to duty off is caused, in which the energization switch 53 is in an off state and the reflux switch 64 in an on state. In this case, current is circulated through a reflux path including the reflux switch 64, whereby the excitation state of the exciting coil 16a is continued.

In addition, in FIG. 9, at timing t32, voltage reduction of the low-voltage battery 21 occurs due to, for example, a disconnection, and a detection signal output from the detection circuit 31 is input to the control device 24. Hence, the reflux switch 64 is turned off by the control device 24, and the charging relay 16 is interrupted immediately after the reflux switch 64 is turned off (timing t33). At this time, current is circulated through the diode 66, which is a power consumption element, whereby the charging relay 16 can be more quickly interrupted. That is, the charging relay 16 can be interrupted before power shutdown of the control device 24 occurs due to the voltage reduction of the low-voltage battery 21.

FIG. 10 (c) indicates a state immediately after the reflux switch 64 is turned off. In this case, current is circulated on the reflux path including the diode 66, and the current rapidly decreases by energization of the diode 66. Hence, the excitation state of the exciting coil 16a is instantaneously canceled, whereby the charging relay 16 is interrupted before the main relay 14 is interrupted. It is noted that, in the present embodiment, the diode 66 corresponds to a relay interruption unit.

According to the present embodiment, if a voltage reduction abnormality of the low-voltage battery 21 has occurred under a state in which both the main relay 14 and the charging relay 16 are closed, the reflux switch 64 is opened, whereby current flows through the reflux path including the exciting coil 16a and the diode 66 (power consumption element). In this case, since power consumption of the diode 66 is higher than that of the reflux switch 64, energy of the exciting coil 16a is instantaneously reduced. Thus, when a voltage abnormality of the low-voltage battery 21 has occurred, the charging relay 16 can be suitably interrupted before the main relay 14 is interrupted.

### Fourth Embodiment

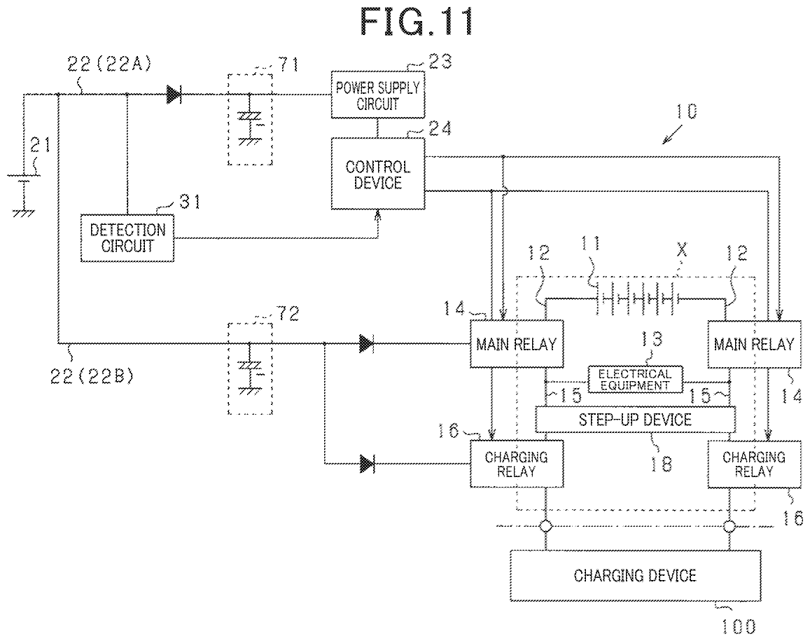

FIG. 11 is a block diagram of the power supply system 10 according to the present embodiment. In FIG. 11, as differences from FIG. 1, the configuration of the backup power supply unit that supplies backup electrical power to the control device 24 and the relays 14, 16 is modified.

In FIG. 11, the control power supply path 22A connecting the low-voltage battery 21 and the power supply circuit 23 is provided with a first backup capacitor 71. The relay power supply path 22B connecting the low-voltage battery 21, and the main relay 14 and the charging relay 16 is provided with a second backup capacitor 72.

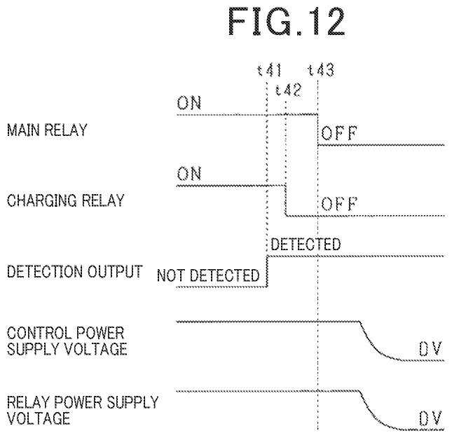

FIG. 12 is a time diagram illustrating operation when charging according to the present embodiment. In FIG. 12, before timing t41, both the main relay 14 and the charging relay 16 are closed (turned on), and at timing t41, a voltage reduction abnormality of the low-voltage battery 21 occurs. In this case, after timing t41, although electrical power supply from the low-voltage battery 21 is stopped, electrical power supply to the control device 24 and the relays 14 and 16 is continued by backup electrical power from the backup capacitors 71, 72.

In addition, at timing t41, a detection signal output from the detection circuit 31 is input to the control device 24. Then, the control device 24 functions as a relay interruption unit and sequentially interrupts the relays 14, 16. Specifically, the charging relay 16 is interrupted at timing t42, and thereafter, the main relay 14 is interrupted at timing t43. After the relays 14 and 16 are interrupted by the control device 24, control power supply voltage and relay power supply voltage decrease due to voltage reduction of the backup capacitors 71, 72.

According to the present embodiment, even if a voltage reduction abnormality of the low-voltage battery 21 suddenly occurs under a state in which both the main relay 14 and the charging relay 16 are closed, closed states of the relays 14, 16 are continued using electrical power supplied from the backup capacitors 71, 72. Hence, during a time period during which electrical power is supplied to the control device 24 and the relays 14, 16 from the backup capacitors 71, 72, the charging relay 16 can be appropriately interrupted before the main relay 14 is interrupted.

### Fifth Embodiment

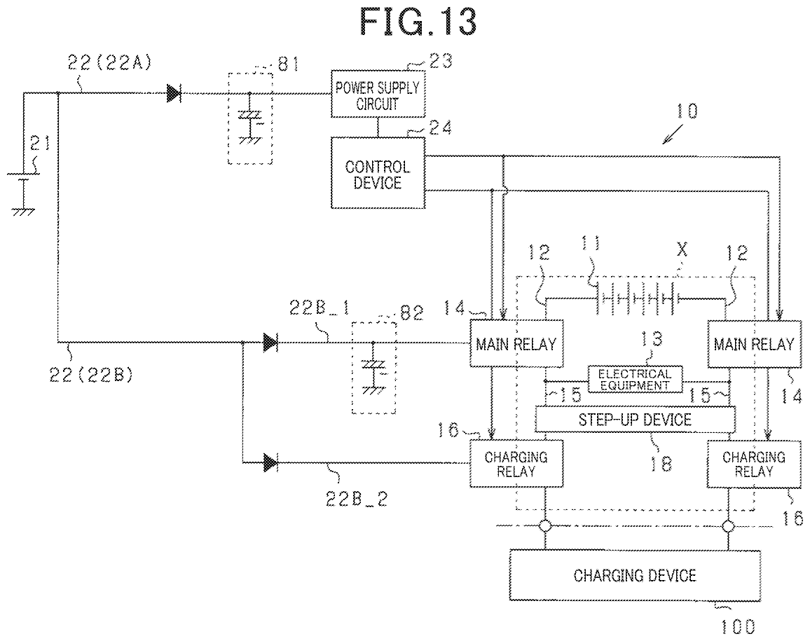

FIG. 13 is a block diagram of the power supply system 10 according to the present embodiment. In the configuration of FIG. 13, part of the configuration of FIG. 12 is modified.

In FIG. 13, the control power supply path 22A connecting the low-voltage battery 21 and the power supply circuit 23 is provided with a first backup capacitor 81. In addition, the relay power supply path 22B connecting the low-voltage battery 21 and the relays 14, 16 branches into a first branched path 22B_1 leading to the main relay 14 and a second branched path 22B_2 leading to the charging relay 16. Of the branched paths 22B_1, 22B_2, the first branched path 22B_1 is provided with a second backup capacitor 82.

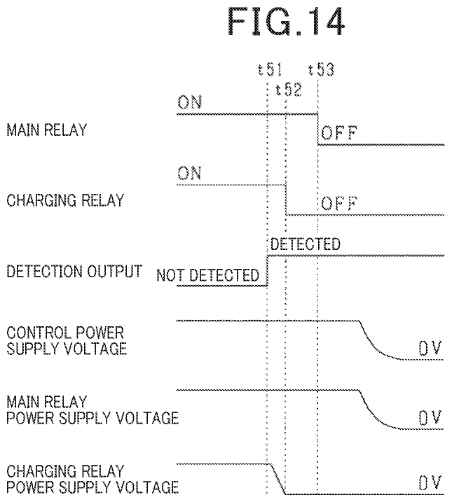

FIG. 14 is a time diagram illustrating operation when charging according to the present embodiment. In FIG. 14, before timing t51, both the main relay 14 and the charging relay 16 are closed (turned on), and at timing t51, a voltage reduction abnormality of the low-voltage battery 21 occurs. In this case, after timing t51, although electrical power supply from the low-voltage battery 21 is stopped, electrical power supply to the control device 24 and the relay 14 is continued by backup electrical power from the backup capacitors 81, 82. It is noted that since backup electrical power is not supplied to the charging relay 16, the charging relay 16 is interrupted before the main relay 14 is interrupted. Specifically, the charging relay 16 is interrupted due to a loss of electrical power at timing t52, and the main relay 14 is interrupted by the control device 24 at the following timing t53.

It is noted that the configuration in which although backup electrical power is supplied to the control device 24 and the main relay 14 from the backup capacitors 81, 82, the backup electrical power is not supplied to the charging relay 16 corresponds to a relay interruption unit.

According to the present embodiment, even if a voltage reduction abnormality of the low-voltage battery 21 suddenly occurs under a state in which both the main relay 14 and the charging relay 16 are closed, at least a closed state of the main relay 14 is continued using electrical power supplied from the backup capacitors 81, 82. In addition, under a state in which backup electrical power is supplied to the control device 24 and the relays 14, the charging relay 16 is opened first by power shutdown. Hence, the charging relay 16 can be appropriately interrupted before the main relay 14 is interrupted.

### Sixth Embodiment

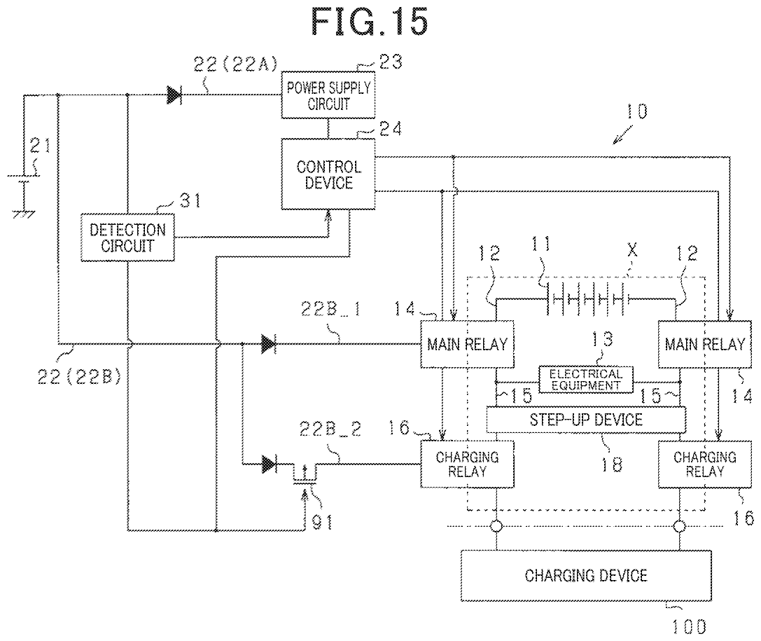

FIG. 15 is a block diagram of the power supply system 10 according to the present embodiment. In the configuration illustrated in FIG. 15, as differences from the above embodiments, a different configuration for forcibly interrupting the charging relay 16 is provided.

As illustrated in FIG. 15, on the relay power supply path 22B connecting the low-voltage battery 21 and the relays 14, 16, of the 15 branched paths 22B_1, 22B_2, the second branched path 22B_2 is provided with an interruption switch 91. The interruption switch 91 is subjected to on-off control by the control device 24. Under an on state, the interruption switch 91 is turned off depending on a detection result of the detection circuit 31. Specifically, if no voltage reduction 20 abnormality of the low-voltage battery 21 has occurred, a non-detection signal is output from the detection circuit 31, whereby an on state of the interruption switch 91 is maintained. In addition, if a voltage reduction abnormality of the low-voltage battery 21 has occurred, a detection signal (abnormality detection signal) is output 25 from the detection circuit 31, whereby the interruption switch 91 is turned off.

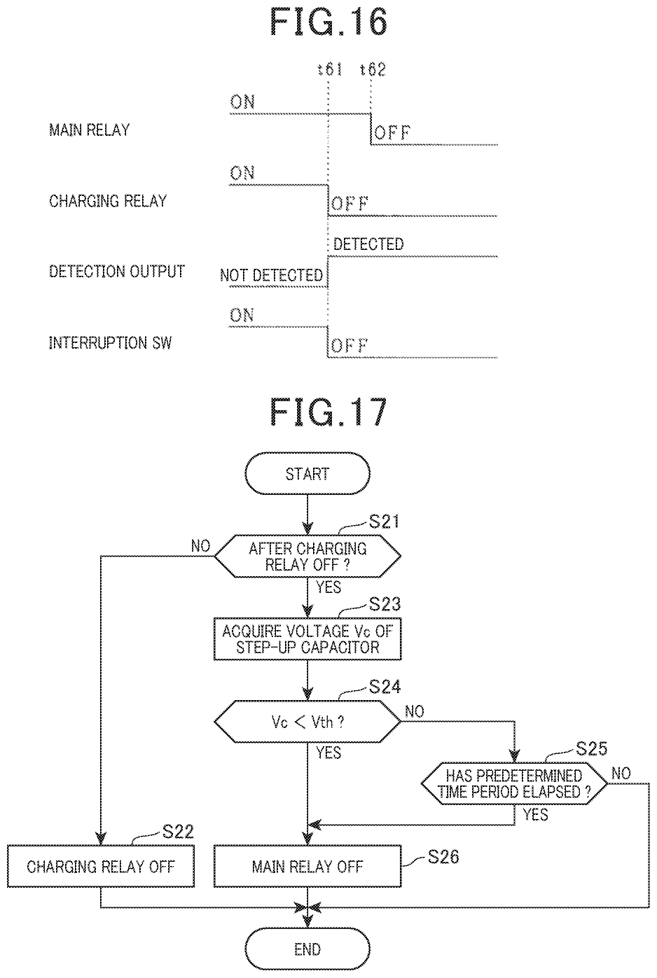

FIG. 16 is a time diagram illustrating operation when charging according to the present embodiment. In FIG. 16, at timing t61 or before, the interruption switch 91 is turned on, and both the main relay 14 and the charging relay 16 are in closed states. At timing t61, when the voltage of the low-voltage battery 21 decreases, a detection signal (abnormality detection signal) is output from the detection circuit 31. Then, the interruption switch 91 is turned off by the detection signal, whereby the second branched path 22B_2 is interrupted, and the charging relay 16 is forcibly interrupted. Thereafter, at timing t62, the main relay 14 is interrupted due to a loss of electrical power. It is noted that the configuration in which the second branched path 22B_2 is interrupted by the interruption switch 91 based on the detection signal of the detection circuit 31 corresponds to a relay interruption unit.

According to the present embodiment, if a voltage reduction abnormality of the low-voltage battery 21 is detected by the detection circuit 31 under a state in which both the main relay 14 and the charging relay 16 are closed, the second branched path 22B_2 is forcibly interrupted by the interruption switch 91 based on the detection signal. Hence, when a voltage reduction abnormality of the low-voltage battery 21 has occurred, the charging relay 16 can be appropriately interrupted before the main relay 14 is interrupted.

### (Modifications)

The above embodiments may be modified, for example, as below.
As a modification of the above first embodiment, the following configuration may be used. The power supply system 10 is configured to include a voltage detection unit that detects a voltage of the step-up capacitor 26. In addition, the control device 24 performs a relay interruption process illustrated in FIG. 17. In the external charging control process in FIG. 2, if a voltage reduction abnormality of the low-voltage battery 21 has occurred, the relay interruption process may be performed in step S18.

In FIG. 17, in step S21, it is determined whether the charging relay 16 has been turned off (after interruption). Then, if the charging relay 16 has not been turned off, the process proceeds to step S22, in which the charging relay 16 is turned off.

If the charging relay 16 has been turned off, the process proceeds to step S23. In step S23, voltage Vc of the step-up capacitor 26 is acquired. In succeeding step S24, it is determined whether the voltage Vc of the step-up capacitor 26 is lower than a predetermined threshold value Vth. In addition, if Vc≥Vth, in step S25, it is determined whether a predetermined time period has elapsed from when the charging relay 16 is turned off. In this case, on condition that the voltage Vc of the step-up capacitor 26 is lower than the threshold value Vth or that the redetermined time period has elapsed from when the charging relay 16 is turned off, the process proceeds to step S26, in which the main relay 14 is turned off.

When the low-voltage battery 21 is abnormal, in a case in which the main relay 14 and the charging relay 16 are interrupted with a time difference therebetween, the time difference is desirably large from the viewpoint of system protection. In this regard, since the main relay 14 is interrupted based on a voltage (detection voltage) of the step-up capacitor 26 after the charging relay 16 is interrupted, a time period from the interruption of the charging relay 16 to the interruption of the main relay 14 can be appropriately controlled while voltage reduction of the step-up capacitor 26 is monitored.
Although the power supply system 10 illustrated in FIG. 1 has a configuration in which the step-up capacitor 26 is used as a backup power supply unit of the control device 24, and the step-down circuit 28 is used as a backup power supply unit of the relays 14, 16, this may be modified to use the same backup power supply unit for the control device 24 and the relays 14, 16. For example, it may be configured to use the step-up capacitor 26 as a backup power supply unit of the control device 24 and the relays 14, 16 or to use the step-down circuit 28 as a backup power supply unit of the control device 24 and the relays 14, 16.
In the power supply system 10 illustrated in FIG. 1, as a backup power supply unit of the control device 24, the auxiliary power supply circuit 42 on the high-voltage side (refer to FIG. 4 and FIG. 6) may be used. Alternatively, as a backup power supply unit of the control device 24, the backup capacitor 71 (refer to FIG. 11) may be used.

The present disclosure has so far been described based on embodiments. However, the present disclosure should not be construed as being limited to these embodiments or the structures. The present disclosure should encompass various modifications, and modifications within the range of equivalence. In addition, various combinations and modes, as well as other combinations and modes, including those which include one or more additional elements, or those which include fewer elements should be construed as being within the scope and spirit of the present disclosure.

A first means includes:
a main relay (14) that is provided on a high-voltage path (12) between a high-voltage battery (11) and electrical equipment (13);
a charging relay (16) provided on a charging path (15) connected between the main relay and the electrical equipment; and
a control device (24) that controls opening and closing of the main relay and the charging relay.

The control device, the main relay, and the charging relay operate using electrical power supplied from a low-voltage battery.

In a state in which the main relay and the charging relay are closed, the high-voltage battery is charged by charging it with power supplied from a charging device (100) via the charging path.

The power supply system further includes a relay interruption unit that interrupts the charging relay before interrupting the main relay if a voltage reduction abnormality of the low-voltage battery has occurred under a state in which both the main relay and the charging relay are closed.

According to the power supply system having the above configuration, when the high-voltage battery is charged, the main relay and the charging relay are closed, whereby the high-voltage battery is charged by charging it with power supplied from the charging device via the charging path. In this case, the control device, the main relay, and the charging relay operate by electrical power supplied from the low-voltage battery. Here, if a voltage reduction abnormality of the low-voltage battery is caused due to a disconnection, a ground fault, or the like, and the main relay is interrupted before the charging relay is interrupted, there is a concern that a malfunction of the electrical equipment connected between the main relay and the charging may be caused.

In this regard, if a voltage reduction abnormality of the low-voltage battery has occurred under a state in which both the main relay and the charging relay are closed, the charging relay is interrupted by the relay interruption unit before the main relay is interrupted. Hence, a malfunction of the electrical equipment, due to the interruption of the main relay before the interruption of the charging relay, can be suppressed. As a result, when the high-voltage battery is charged, even if a voltage reduction abnormality of the low-voltage battery occurs, appropriate measures can be taken.

In the first means, a second means includes a backup power supply unit (26,28,42) that supplies backup electrical power to the control device, the main relay, and the charging relay. The control device functions as the relay interruption unit, and interrupts the charging relay before interrupting the main relay during a time period during which the backup electrical power is supplied to the main relay and the charging relay, if a voltage reduction abnormality of the low-voltage battery has occurred under a state in which both the main relay and the charging relay are closed.

According to the configuration including the backup power supply unit that supplies backup electrical power to the control device, the main relay, and the charging relay, even if a voltage reduction abnormality of the low-voltage battery suddenly occurs under a state in which both the main relay and the charging relay are closed, closed states of the relays are continued using backup electrical power supplied to the main relay and the charging relay. Hence, during a time period during which the backup electrical power is supplied to the relays, the charging relay can be appropriately interrupted before the main relay is interrupted.

In the second means, a third means is a power supply system that includes a step-up capacitor (26) that stores boosted voltage obtained by boosting battery voltage of the low-voltage battery and a step-down circuit (28) that drops the boosted voltage of the step-up capacitor. When starting charging the high-voltage battery by charging power supplied from the charging device is commenced, the boosted voltage of the step-up capacitor is applied to shift the main relay and the charging relay from an opened state to a closed state. After the commencement, the applied voltage is changed to dropped voltage of the step-down circuit to hold the closed states of the main relay and the charging relay. The step-up capacitor and the step-down circuit are included as the backup power supply unit, and dropped electrical power of the step-down circuit is supplied to the main relay and the charging relay as the backup electrical power, if a voltage reduction abnormality of the low-voltage battery has occurred under a state in which both the main relay and the charging relay are closed.

When starting charging the high-voltage battery using charging power supplied from the charging device is commenced, boosted voltage of the step-up capacitor is applied to shift the main relay and the charging relay from opened states to a closed states. Thereafter, the applied voltage is changed to dropped voltage of the step-down circuit to hold the closed states of the main relay and the charging relay. Hence, when the high-voltage battery is charged by the charging device, reliable relay drive can be performed by the boosted voltage of the step-up capacitor, and the relays can be driven using saved energy with the dropped voltage.

In addition, if a voltage reduction abnormality of the low-voltage battery has occurred under a state in which both the main relay and the charging relay are closed, the dropped electrical power of the step-down circuit is supplied to the main relay and the charging relay as backup electrical power. Hence, even in a state in which electrical 25 power supply from the low-voltage battery to the step-up capacitor is stopped, the supply of backup electrical power to the relays can be prolonged.

In the third means, a fourth means includes a voltage detection unit that detects a voltage of the step-up capacitor. The control device interrupts the main relay based on a detection voltage of the voltage detection unit after the charging relay is interrupted, if a voltage reduction abnormality of the low-voltage battery has occurred under a state in which both the main relay and the charging relay are closed.

When the low-voltage battery is abnormal, in a case in which the main relay and the charging relay are interrupted with a time difference therebetween, the time difference is desirably large from the viewpoint of system protection. In this regard, since the main relay is interrupted based on a voltage (detection voltage) of the step-up capacitor after the charging relay is interrupted, a time period from the interruption of the charging relay to the interruption of the main relay can be appropriately controlled while voltage reduction of the step-up capacitor is monitored.

In the second means, a fifth means includes an auxiliary power supply unit (42), as the backup power supply unit, which uses the high-voltage battery to generate the backup electrical power. The auxiliary power supply unit supplies the backup electrical power to the control device, the main relay, and the charging relay, if a voltage reduction abnormality of the low-voltage battery has occurred under a state in which both the main relay and the charging relay are closed.

The auxiliary power supply unit supplies the backup electrical power to the control device, the main relay, and the charging relay, if a voltage reduction abnormality of the low-voltage battery has occurred under a state in which both the main relay and the charging relay are closed. Hence, even in a state in which electrical power supply from the low-voltage battery is stopped, the relays can be appropriately interrupted by the control device while supply of backup electrical power to the relays is continued. In addition, in the above configuration, since the auxiliary power supply circuit generates backup electrical power using the high-voltage battery, the time limit until backup electrical power is lost after the change to the backup electrical power can be eliminated.

In the first means, in a sixth means, the control device outputs a duty signal when closing the charging relay, to control electrical power supply from the low-voltage battery to an exciting coil (16a) of the charging relay. In addition, the power supply system includes a first path (61) and a second path (62) that are provided in parallel across both ends of the exciting coil, the first path and the second path respectively forming reflux paths including the exciting coil. The first path is provided with a reflux switch (64) that opens and closes the first path. The second path is provided with, as the relay interruption unit, a power consumption element (66) whose power consumption is higher than that of the reflux switch. Then, when the charging relay is closed together with the main relay, when a shift from duty on to duty off is caused, reflux is generated via the closed reflux switch. In addition,
the reflux switch is opened to generate reflux via the power consumption element to interrupt the charging relay, if a voltage reduction abnormality of the low-voltage battery has occurred under a state in which both the main relay and the charging relay are closed.

When the charging relay is closed by the duty signal, the reflux switch provided to the first path is kept to a closed state. Hence, when a shift from duty on to duty off is caused, current flows through a reflux path including the exciting coil and the reflux switch, whereby the closed state of the charging relay can be maintained. In addition, if a voltage reduction abnormality of the low-voltage battery has occurred under a state in which both the main relay and the charging relay are closed, the reflux switch is opened, whereby current flows through the reflux path including the exciting coil and the power consumption element. In this case, since power consumption of the power consumption element is higher than that of the reflux switch, energy of the exciting coil is instantaneously reduced. Thus, when a voltage abnormality of the low-voltage battery has occurred, the charging relay can be suitably interrupted before the main relay is interrupted.

In the first means, a seventh means includes a first backup capacitor (71) provided to a control power supply path (22A) connecting the low-voltage battery and a power supply circuit (23), which is a front stage of the control device, and a second backup capacitor (72) provided to a relay power supply path (22B) connecting the low-voltage battery, and the main relay and the charging relay. In addition, the control device functions as the relay interruption unit, and interrupts the charging relay before interrupting the main relay under an operation state in which electrical power is supplied from the first backup capacitor, if a voltage reduction abnormality of the low-voltage battery has occurred under a state in which both the main relay and the charging relay are closed.

According to the configuration in which the first backup capacitor is provided to a control power supply path connecting the low-voltage battery and a power supply circuit, which is a front stage of the control device, and the second backup capacitor is provided to a relay power supply path connecting the low-voltage battery, and the main relay and the charging relay, even if a voltage reduction abnormality of the low-voltage battery suddenly occurs under a state in which both the main relay and the charging relay are closed, closed states of the relays are continued using electrical power supplied from the backup capacitors. Hence, during a time period during which electrical power is supplied to the control device and the relays from the backup capacitors, the charging relay can be appropriately interrupted before the main relay is interrupted.

In the first means, an eighth means includes a control power supply path (22A) that connects the low-voltage battery and a power supply circuit (23), which is a front stage of the control device, and a relay power supply path (22B) that connects the low-voltage battery, and the main relay and the charging relay. The relay power supply path branches into a first branched path (22B_1) leading to the main relay and a second branched path (22B_2) leading to the charging relay. The control power supply path is provided with a first backup capacitor (81). Of the first branched path and the second branched path, the first branched path is provided with a second backup capacitor (82). In addition, the relay interruption unit has a configuration in which although backup electrical power is supplied to the control device and the main relay from the backup capacitors, the backup electrical power is not supplied to the charging relay, if a voltage reduction abnormality of the low-voltage battery has occurred under a state in which both the main relay and the charging relay are closed.

According to the configuration in which the first backup capacitor is provided to the control power supply path connecting the low-voltage battery and the power supply circuit, which is a front stage of the control device, and the second backup capacitor is provided to the first branched path connecting the low-voltage battery and the main relay, even if a voltage reduction abnormality of the low-voltage battery suddenly occurs under a state in which both the main relay and the charging relay are closed, at least a closed state of the main relay is continued using backup electrical power supplied from the backup capacitors. In addition, under a state in which backup electrical power is supplied to the control device and the relays, the charging relay is opened first by power shutdown because the backup electrical power is not supplied to the charging relay. Hence, the charging relay can be appropriately interrupted before the main relay is interrupted.

In the first means, a ninth means includes a relay power supply path (22B) that connects the low-voltage battery, and the main relay and the charging relay, and a detection circuit (31) that detects occurrence of a voltage reduction abnormality of the low-voltage battery. The relay power supply path branches into a first branched path (22B_1) leading to the main relay and a second branched path (22B_2) leading to the charging relay, the second branched path being provided with an interruption switch (91). In addition, the relay interruption unit is configured to interrupt the second branched path by the interruption switch based on an abnormality detection signal of the detection circuit under a state in which both the main relay and the charging relay are closed.

If a voltage reduction abnormality of the low-voltage battery is detected by the detection circuit under a state in which both the main relay and the charging relay are closed, the second branched path is forcibly interrupted by the interruption switch based on the abnormality detection signal. Hence, when a voltage reduction abnormality of the low-voltage battery has occurred, the charging relay can be appropriately interrupted before the main relay is interrupted.

What is claimed is:

1. A power supply system, comprising:
a main relay that is provided on a high-voltage path between a high-voltage battery and electrical equipment;
a charging relay provided on a charging path connected between the main relay and the electrical equipment; and
a control device that controls opening and closing of the main relay and the charging relay, wherein
the control device, the main relay, and the charging relay operate using electrical power supplied from a low-voltage battery,
in a state in which the main relay and the charging relay are closed, the high-voltage battery is charged by charging it with power supplied from a charging device via the charging path, and
the power supply system further comprises a relay interruption unit that interrupts the charging relay before interrupting the main relay if a voltage reduction abnormality of the low-voltage battery has occurred under a state in which both the main relay and the charging relay are closed.

2. The power supply system according to claim 1, further comprising a backup power supply unit that supplies backup electrical power to the control device, the main relay, and the charging relay, wherein
the control device functions as the relay interruption unit, and interrupts the charging relay before interrupting the main relay during a time period during which the backup electrical power is supplied to the main relay and the charging relay, if a voltage reduction abnormality of the low-voltage battery has occurred under a state in which both the main relay and the charging relay are closed.

3. The power supply system according to claim 2, further comprising a step-up capacitor that stores boosted voltage obtained by boosting battery voltage of the low-voltage battery and a step-down circuit that drops the boosted voltage of the step-up capacitor,
when starting charging the high-voltage battery by charging power supplied from the charging device is commenced, the boosted voltage of the step-up capacitor is applied to shift the main relay and the charging relay from an opened state to a closed state,
after the commencement, the applied voltage is changed to dropped voltage of the step-down circuit to hold the closed states of the main relay and the charging relay,
the step-up capacitor and the step-down circuit are included as the backup power supply unit, and
dropped electrical power of the step-down circuit is supplied to the main relay and the charging relay as the backup electrical power, if a voltage reduction abnormality of the low-voltage battery has occurred under a state in which both the main relay and the charging relay are closed.

4. The power supply system according to claim 3, further comprising a voltage detection unit that detects a voltage of the step-up capacitor, wherein
the control device interrupts the main relay based on a detection voltage of the voltage detection unit after the charging relay is interrupted, if a voltage reduction abnormality of the low-voltage battery has occurred under a state in which both the main relay and the charging relay are closed.

5. The power supply system according to claim 2, further comprising an auxiliary power supply unit, as the backup power supply unit, which uses the high-voltage battery to generate the backup electrical power, wherein
the auxiliary power supply unit supplies the backup electrical power to the control device, the main relay, and the charging relay, if a voltage reduction abnormality of the low-voltage battery has occurred under a state in which both the main relay and the charging relay are closed.

6. The power supply system according to claim 1, wherein
the control device outputs a duty signal when closing the charging relay, to control electrical power supply from the low-voltage battery to an exciting coil of the charging relay,
the power supply system includes a first path and a second path that are provided in parallel across both ends of the exciting coil, the first path and the second path respectively forming reflux paths including the exciting coil,
the first path is provided with a reflux switch that opens and closes the first path,
the second path is provided with, as the relay interruption unit, a power consumption element whose power consumption is higher than that of the reflux switch,
when the charging relay is closed together with the main relay, when a shift from duty on to duty off is caused, reflux is generated via the closed reflux switch, and
the reflux switch is opened to generate reflux via the power consumption element to interrupt the charging relay, if a voltage reduction abnormality of the low-voltage battery has occurred under a state in which both the main relay and the charging relay are closed.

7. The power supply system according to claim 1, further comprising:
a first backup capacitor provided to a control power supply path connecting the low-voltage battery and a power supply circuit, which is a front stage of the control device, and
a second backup capacitor provided to a relay power supply path connecting the low-voltage battery, and the main relay and the charging relay, wherein
the control device functions as the relay interruption unit, and interrupts the charging relay before interrupting the main relay under an operation state in which electrical power is supplied from the first backup capacitor, if a voltage reduction abnormality of the low-voltage battery has occurred under a state in which both the main relay and the charging relay are closed.

8. The power supply system according to claim 1, further comprising:
a control power supply path that connects the low-voltage battery and a power supply circuit, which is a front stage of the control device, and
a relay power supply path that connects the low-voltage battery, and the main relay and the charging relay, wherein
the relay power supply path branches into a first branched path leading to the main relay and a second branched path leading to the charging relay,
the control power supply path is provided with a first backup capacitor,
of the first branched path and the second branched path, the first branched path is provided with a second backup capacitor, and
the relay interruption unit has a configuration in which although backup electrical power is supplied to the control device and the main relay from the backup capacitors, the backup electrical power is not supplied to the charging relay, if a voltage reduction abnormality of the low-voltage battery has occurred under a state in which both the main relay and the charging relay are closed.

9. The power supply system according to claim 1, further comprising:
a relay power supply path that connects the low-voltage battery, and the main relay and the charging relay; and
a detection circuit that detects occurrence of a voltage reduction abnormality of the low-voltage battery, wherein
the relay power supply path branches into a first branched path leading to the main relay and a second branched path leading to the charging relay, the second branched path being provided with an interruption switch, and
the relay interruption unit is configured to interrupt the second branched path by the interruption switch based on an abnormality detection signal of the detection circuit under a state in which both the main relay and the charging relay are closed.
